(19) United States
(12) Patent Application Publication
(10) Pub. No.: US 2025/0326654 A1
(43) Pub. Date: Oct. 23, 2025

(54) METHODS FOR CALCINING GYPSUM

(71) Applicant: GEORGIA-PACIFIC GYPSUM LLC, Atlanta, GA (US)

(72) Inventors: Randy B. Carpenter, Las Vegas, NV (US); Ronald W. Causey, Overton, NV (US); Jennifer L. Plummer, Westmoreland, KS (US)

(21) Appl. No.: 18/871,159

(22) PCT Filed: Jun. 23, 2023
(86) PCT No.: PCT/IB2023/056513

§ 371 Date: Dec. 3, 2024

Related U.S. Application Data
(60) Provisional application No. 63/389,387, filed on Jul. 15, 2022.

(51) Int. Cl. C01F 11/46

(52) U.S. Cl. CPC C01F 11/466; C01P 2006/82; C01P 2006/90

(57) ABSTRACT

A method for calcining gypsum includes subjecting a composition including gypsum dihydrate to a predetermined vacuum. The method further includes maintaining the composition under the at least partial vacuum at a calcining temperature for a predetermined calcining time. The calcining temperature may be in a range from 60° C. to 125° C., or in a range from 65° C. to 85° C. The vacuum may be in a range from 25 mbar to 50 mbar. The predetermined calcining time may be in a range from 3 hours to 10 hours. The maintaining is effective to at least partially remove water of crystallization from the gypsum dihydrate to convert the composition to a product including gypsum hemihydrate.

### CROSS-REFERENCE TO RELATED APPLICATIONS

The present application claims the benefit of priority to U.S. Provisional Application Ser. No. 63/389,387, titled “METHODS FOR CALCINING GYPSUM,” filed Jul. 15, 2022, the contents of which are incorporated herein by reference in their entirety for any purpose.

### BACKGROUND

The present disclosure relates generally to the field of gypsum processing, and more particularly to methods for forming gypsum hemihydrate.

A precursor material including gypsum (calcium sulfate dihydrate) may be treated at high temperature (for example, calcining) to produce a product including gypsum hemihydrate (calcium sulfate hemihydrate). Gypsum hemihydrate occurs in two forms, alpha-hemihydrate gypsum and beta-hemihydrate gypsum. The processing time, processing cost, product properties, and form of gypsum hemihydrate produced depend on the calcining parameters.

A need remains for improved processes for producing gypsum hemihydrate.

### SUMMARY

The present disclosure describes methods for calcining gypsum under vacuum using relatively low temperatures.

In aspects, a method for calcining gypsum includes subjecting a composition including gypsum dihydrate to a predetermined vacuum. The method further includes maintaining the composition under the at least partial vacuum at a calcining temperature for a predetermined calcining time. The calcining temperature may be in a range from 60° C. to 125° C. The maintaining is effective to at least partially remove water of crystallization from the gypsum dihydrate to convert the composition to a product including gypsum hemihydrate.

In an aspect, a method for calcining gypsum includes subjecting a composition including gypsum dihydrate to a vacuum of from 25 mbar to 50 mbar. The method further includes maintaining the composition under the at least partial vacuum at a calcining temperature of from 65° to 85° C. for a predetermined calcining time of from 3 hours to 10 hours. The maintaining is effective to at least partially remove water of crystallization from the gypsum dihydrate to convert the composition to a product comprising gypsum hemihydrate.

### BRIEF DESCRIPTION OF THE DRAWINGS

Referring now to the drawings, which are meant to be exemplary and not limiting, and wherein like elements are numbered alike. The detailed description is set forth with reference to the accompanying drawings illustrating examples of the disclosure, in which use of the same reference numerals indicates similar or identical items. Certain embodiments of the present disclosure may include elements, components, and/or configurations other than those illustrated in the drawings, and some of the elements, components, and/or configurations illustrated in the drawings may not be present in certain embodiments.

FIG. 1 is a chart showing a change in moisture content with time for a sample of gypsum dihydrate maintained at 60° C. under vacuum.

FIG. 2 is a chart showing a change in moisture content with time for a sample of gypsum dihydrate maintained at 85° C. under vacuum.

### DETAILED DESCRIPTION OF THE PREFERRED EMBODIMENTS

The present disclosure provides methods for forming a product including gypsum hemihydrate from a composition including gypsum dihydrate. Gypsum hemihydrate compositions, such as plaster of Paris or stucco, set by rehydration when water is added, and may be used to mold and fabricate a variety of products.

Gypsum dihydrate may be obtained in raw form by quarrying or mining, and further processed to ultimately produce gypsum hemihydrate products. The processing may include heating to remove free moisture, and to remove moisture bound in gypsum crystals as water of crystallization. Calcining is a heat treatment that liberates water of crystallization to convert the gypsum dihydrate to gypsum hemihydrate.

Typical processes for manufacturing gypsum hemihydrate use elevated temperatures, for example, 150° C. or higher, and/or high pressure. The use of elevated temperatures may require the use of certain types of fuels or energy sources, having associated energy costs. The elevated temperatures and pressures may also reduce the strength of the resulting products. The use of elevated temperatures and pressures may also increase manufacturing time. Certain processes use steam, or process a slurry of gypsum dihydrate, for example, as disclosed in published U.S. Application US 2009/0208392.

The present disclosure provides methods that use relatively lower temperatures, for example, temperatures lower than 150° C., or lower than 125° C., or even lower, such as 85° C., to achieve calcining. Vacuum may be applied to facilitate the treatment at lower temperature.

The term “vacuum” in the present disclosure does not require absolute vacuum. Rather, the term encompasses pressures lower than the environmental pressure, or lower than the standard atmospheric pressure. The vacuum is numerically described throughout the disclosure in terms of absolute pressure.

It was surprisingly found that temperatures lower than those conventionally used in calcining were effective to convert gypsum dihydrate to gypsum hemihydrate, when the gypsum dihydrate was heated in a vacuum. Thus, gypsum hemihydrate may be formed without requiring significantly high temperatures and high pressures, or steam, or forming a slurry.

In aspects, a method for calcining gypsum includes subjecting a composition including gypsum dihydrate to a predetermined vacuum. The method further includes maintaining the composition under the at least partial vacuum at a calcining temperature for a predetermined calcining time. The calcining temperature may be in a range from 60° C. to 125° C. The maintaining is effective to at least partially remove water of crystallization from the gypsum dihydrate to convert the composition to a product including gypsum hemihydrate.

The composition including gypsum dihydrate may include so-called “raw” gypsum, which may be in the form of blocks, chunks, cubes, powder, or aggregated form. The composition may include free moisture, and impurities such as minerals. The composition may be pre-processed, for example, by screening, aeration, size reduction, or moisture reduction, to remove one or more components. The screening may include passing the composition through sieves or other separation media. The size reduction may include passing the composition through mills, breakers, compactors, or the like. The pre-processing may include an initial heating that is sufficient to drive off free moisture from the composition. For example, the composition may be heated in an oven, kettle, or chamber.

One or both of the optional pre-processing or subsequent calcining may be performed as a batch or a continuous process. In aspects, discrete batches of the composition may be pre-processed or calcined. In other aspects, the composition may be continuously pre-processed or calcined, for example, being transported on a conveyor, or through pipes, or any suitable means for transporting material, through one or more zones or stages of treatment or processing. In other aspects, a combination of batch and continuous processing may be used.

In aspects, the composition may be subjected to a predetermined vacuum. For example, the composition may be introduced into a container such as kettle, and the container may be depressurized. In aspects, the container holding the material may be introduced into a vacuum chamber, which may be depressurized.

Any suitable order of depressurizing/vacuum or heating may be used. For example, the composition may be heated before, during, or after being subjected to vacuum. In aspects, the composition may be heated from an initial temperature, for example, room temperature, to a predetermined calcining temperature, and then subjected to vacuum. In other aspects, the composition may be simultaneously heated to the predetermined calcining temperature and depressurized to a predetermined vacuum. In still other aspects, the composition may be initially depressurized to the predetermined vacuum, and then heated to the predetermined calcining temperature.

Regardless of the order of heating and depressurizing, the composition may be held or maintained at the predetermined calcining temperature under the predetermined vacuum for a predetermined calcining time. In aspects, the time needed to heat or depressurize the composition may be relatively short compared to the predetermined calcining time. For example, the composition may be depressurized or heated in a few seconds, a minute, or a few minutes, and held at the predetermined calcining time for a few hours or longer. In some aspects, one or both of the heating or depressurizing may proceed in stages, for example, through a series of temperatures or vacuums before a final temperature and vacuum is achieved. In some such aspects, the composition may be maintained for respective predetermined periods at various temperatures or vacuums, or may be continuously subjected to increasing or decreasing temperatures or vacuums.

Thus, methods according to the present disclosure may include heating the composition to the calcining temperature. In some aspects, the heating is initiated before the subjecting the composition to the predetermined vacuum. In other aspects, the heating is initiated during or after the subjecting the composition to the predetermined vacuum. The heating may be performed using any suitable heater, for example, an electric heater or a gas heater.

The composition may be heated, depressurized, or maintained at the predetermined calcining temperature for the predetermined calcining time at the predetermined calcining vacuum in a static environment, in which there is no substantial flow of air or gas in the container or chamber in which the composition is held. In some aspects, the composition may be subject to a laminar, convective, or turbulent flow, for example, applied by a blower or a fan. The flow of air or gas may promote maintaining a uniform temperature throughout the composition, or may promote removal of free moisture or moisture freed from the crystalline structure, to maintain a moisture differential from the composition to the environment and prevent or reduce rehydration of the composition. If a surface is heated, an agitator can be used to continuously maintain product movement to prevent the material from being damaged by locally high temperatures near the heated surface. Gas can optionally be introduced in conjunction with mechanical agitation, subject to maintaining the desired vacuum. In some aspects, there may be no additional flow other than any incidental to the generation or maintaining of the vacuum.

Any suitable calcining temperatures that are sufficiently high to at least partially extract water of crystallization may be used. The calcining temperatures may be sufficiently low to avoid any undesirable effects on the product, for example, to prevent or reduce lowering of product strength associated with exposure to elevated temperatures.

In aspects, the calcining temperature is less than or equal to 120° C. In some aspects, the calcining temperature is in a range from 60° C. to 100° C. In some aspects, the calcining temperature is in a range from 65° C. to 85° C. In some aspects, the calcining temperature is 85° C. While particular ranges and values of temperatures are described in the disclosure, a variation within +5° C., or within +1° C., may be acceptable.

In some aspects, the calcining temperature is a first calcining temperature, and the predetermined calcining time is a first predetermined calcining time. In some such aspects, methods according to the disclosure may further include maintaining the composition under the at least partial vacuum at a second calcining temperature for a predetermined second calcining time. In some such aspects, the second calcining temperature is greater than the first calcining temperature and less than 125° C.

Any suitable vacuum that allows the use of relatively lower calcining temperatures may be used. For example, suitable levels of vacuum may include pressures less than atmospheric (1013.2 mbar at sea level) and greater than 1 mbar, for example 5 to 200 mbar, for example 10 to 100 mbar. In one aspect, the predetermined vacuum is in a range from 25 mbar to 50 mbar. Within these ranges, it is understood that the skilled person would take into account the operating temperature and the feed mixture to adjust the optimum vacuum level using a reasonable amount of trial and error.

A single or constant predetermined vacuum may be applied, or different or varying vacuums may be used. In aspects, the predetermined vacuum is a first predetermined vacuum, the composition may be maintained under a second predetermined vacuum deeper than the first predetermined vacuum. In other aspects, the second predetermined vacuum may be lighter than the first predetermined vacuum.

Any suitable calcining time may be used. For example, the calcining time may be associated with at least a partial extent of removal of water of crystallization for known temperature and vacuum conditions. In aspects, the calcining time is sufficient to reduce moisture content to below 10%, or to below 7%, or to below 6% w/w, of the composition. For example, a moisture content below 10% w/w may be indicative of at least partial conversion of gypsum dihydrate to gypsum hemihydrate, and a moisture content below 6% w/w may be indicative of substantially complete, for example, at least 99%, or at least 99.9%, of gypsum dihydrate to gypsum hemihydrate.

In aspects, the predetermined calcining time is at least 1 hour. In aspects, the predetermined calcining time is at least 3 hours. In aspects, the predetermined calcining time is at least 5 hours. In aspects, the predetermined calcining time is at least 10 hours.

In aspects, the product has a moisture content of less than 10% by weight, or less than 9% by weight, or less than 8% by weight, or less than 7% by weight, or less than 6% by weight.

The calcining time may be sufficiently short to avoid high energy costs, to reduce or avoid thermal damage to the composition or to the product, or to promote the speed of production. In some aspects, the predetermined calcining time is less than 20 hours. In some aspects, the predetermined calcining time is less than 10 hours. In some aspects, the predetermined calcining time is less than 5 hours.

While the raw or precursor compositions include gypsum dihydrate, the compositions may include moisture, impurities, additives, or other components. In aspects, the composition consists of gypsum dihydrate. In aspects, the composition consists essentially of gypsum dihydrate. In other aspects, the composition contains up to 7% moisture, for example, up to 10% moisture. In various aspects, the composition can contain up to 7% impurities, and in other aspects, up to 1% impurities.

The calcined product may include one or more forms of gypsum hemihydrate. For example, the gypsum hemihydrate may include one or both of alpha gypsum hemihydrate or beta gypsum hemihydrate. In aspects, the gypsum hemihydrate consists of or consists essentially of alpha gypsum hemihydrate. In aspects, the gypsum hemihydrate consists of or consists essentially of beta gypsum hemihydrate. If a particular form of the hemihydrate is desired in the product, another form of the hemihydrate may be considered as an impurity, but may yet be acceptable to a certain extent.

The product including gypsum hemihydrate may be characterized by having a greater compressive strength than gypsum hemihydrate products produced by conventional high temperature calcining processes. In aspects, the product has a compressive strength of at least 2700 psi. In aspects, the product has a compressive strength of at least 3000 psi. In aspects, the product has a compressive strength of at least 3400 psi.

In an aspect, a method for calcining gypsum includes subjecting a composition including gypsum dihydrate to a vacuum of from 25 mbar to 50 mbar. The method further includes maintaining the composition under the at least partial vacuum at a calcining temperature of from 65° to 85° C. for a predetermined calcining time of from 3 hours to 10 hours. The maintaining is effective to at least partially remove water of crystallization from the gypsum dihydrate to convert the composition to a product comprising gypsum hemihydrate. In some such aspects, the product consists of or consists essentially of beta gypsum hemihydrate. In some such aspects, the product has a compressive strength of at least 3000 psi.

### EXAMPLES

### Example 1

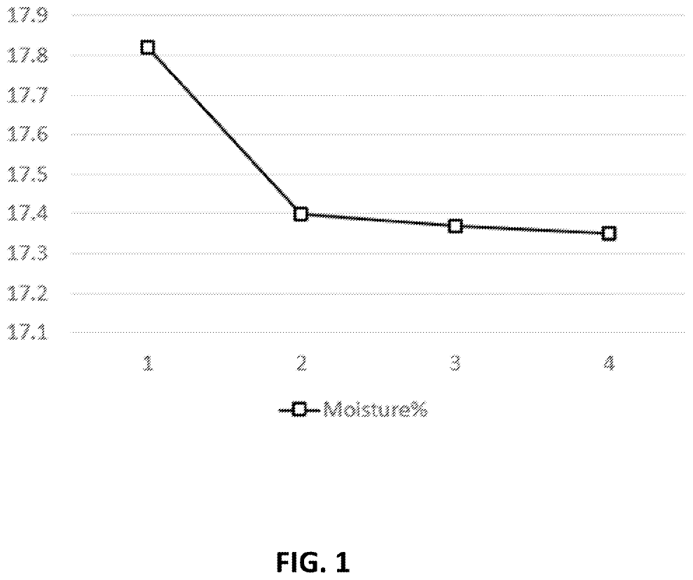

A gypsum sample including gypsum dihydrate was maintained under vacuum (50 mbar) at 60° C. After two hours, the moisture content was reduced to 17.4% w/w. Beyond two hours, no significant reduction in moisture content was achieved. FIG. 1 is a chart showing a change in moisture content with time for the sample of gypsum dihydrate maintained at 60° C. under vacuum. TABLE 1 is a table showing the change in moisture content with time for the sample.

TABLE 1

| Cook Time | Moisture |
|---|---|
| (hours) | (% w/w) |
| 1 | 17.82 |
| 2 | 17.4 |
| 3 | 17.37 |
| 4 | 17.35 |

The results indicate that free moisture was removed, but that water of crystallization was not removed.

### Example 2

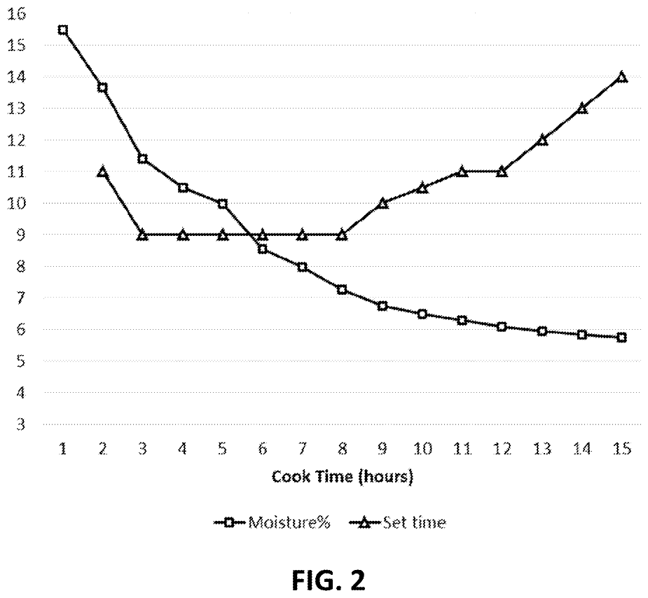

A gypsum sample including gypsum dihydrate was maintained under vacuum (50 mbar) at 85° C. FIG. 2 is a chart showing a change in moisture content with time for a sample of gypsum dihydrate maintained at 85° C. under vacuum. TABLE 2 is a table showing the change in moisture content with time for the sample.

TABLE 2

| Cook Time | Moisture | Pat size | Set time | Compressive |
|---|---|---|---|---|
| (hours) | (% w/w) | (in.) | (minutes) | Strength |
| 2 | 15.48 | | | |
| 2.5 | 13.65 | 4 | 11 | |
| 3 | 11.39 | 4.5 | 9 | |
| 3.5 | 10.49 | 4.625 | 9 | |
| 4 | 9.97 | 4.625 | 9 | 1663 |
| 4.5 | 8.55 | 4.625 | 9 | |
| 5 | 7.98 | 4.38 | 9 | |
| 5.5 | 7.26 | 4.38 | 9 | |
| 6 | 6.74 | 4.18 | 10 | |
| 6.5 | 6.49 | 4 | 10.5 | 3103 |
| 7 | 6.28 | 4 | 11 | |
| 7.5 | 6.09 | 3.94 | 11 | |
| 8 | 5.95 | 4 | 12 | 3438 |
| 8.5 | 5.84 | 3.94 | 13 | |
| 9 | 5.76 | 3.88 | 14 | 2967 |

The moisture content was progressively reduced to lower than 6% w/w, indicating that water of crystallization was removed. Acceptable set times and compressive strengths were associated with different calcining times, for example, calcining of over 6 hours.

The compressive strength of beta gypsum hemihydrate produced by conventional processes is under 2700 psi. The sample at different stages of calcining had a greater compressive strength.

While the disclosure has been described with reference to a number of embodiments, it will be understood by those skilled in the art that the invention is not limited to such disclosed embodiments. Rather, the invention can be modified to incorporate any number of variations, alterations, substitutions, or equivalent arrangements not described herein, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A method for calcining gypsum, the method comprising: subjecting a composition comprising gypsum dihydrate to a predetermined vacuum; and maintaining the composition under the predetermined vacuum at a calcining temperature for a predetermined calcining time, wherein the calcining temperature is in a range from 60° C. to 125° C., and wherein the maintaining is effective to at least partially remove water of crystallization from the gypsum dihydrate to convert the composition to a product comprising gypsum hemihydrate,
wherein the composition comprises at least 83% of gypsum dihydrate by weight when the composition is initially subjected to the predetermined vacuum.

2. (canceled)

3. The method of claim 1, wherein the calcining temperature is in a range from 60° C. to 100° C.

4. The method of claim 3, wherein the calcining temperature is in a range from 65° C. to 85° C.

5. (canceled)

6. (canceled)

7. The method of claim 1, further comprising heating the composition to the calcining temperature, wherein the heating is initiated before the subjecting the composition to the predetermined vacuum.

8. The method of claim 1, further comprising heating the composition to the calcining temperature, wherein the heating is initiated during or after the subjecting the composition to the predetermined vacuum.

9. The method of claim 1, wherein the calcining temperature is a first calcining temperature, wherein the predetermined calcining time is a first predetermined calcining time, and wherein the method further comprises maintaining the composition under the predetermined vacuum at a second calcining temperature for a predetermined second calcining time, wherein the second calcining temperature is greater than the first calcining temperature and less than 125° C.

10. (canceled)

11. The method of claim 1, wherein the predetermined vacuum is in a range selected from the group consisting of:
(a) pressures less than atmospheric (1013.2 mbar at sea level) and greater than 1 mbar;
(b) 5 to 200 mbar;
(c) 10 to 100 mbar; and
(d) 25 mbar to 50 mbar.

12. The method of claim 1, wherein the predetermined vacuum is a first predetermined vacuum, and wherein the method further comprises maintaining the composition under a second predetermined vacuum deeper than the first predetermined vacuum.

13. (canceled)

14. (canceled)

15. The method of claim 1, wherein the predetermined calcining time is at least 5 hours.

16. (canceled)

17. (canceled)

18. (canceled)

19. (canceled)

20. The method of claim 1, wherein the composition consists of the gypsum dihydrate comprising the water of crystallization.

21. (canceled)

22. The method of claim 1, wherein the gypsum hemihydrate consists of alpha gypsum hemihydrate.

23. The method of claim 1, wherein the gypsum hemihydrate consists of beta gypsum hemihydrate.

24. The method of claim 1, wherein the product has a compressive strength of at least 2700 psi.

25. The method of claim 1, wherein the product has a compressive strength of at least 3000 psi.

26. (canceled)

27. The method of claim 1, wherein the product has a moisture content of less than 6% by weight.

28. A method for calcining gypsum, the method comprising: subjecting a composition comprising gypsum dihydrate to a vacuum of from 25 mbar to 50 mbar; and maintaining the composition under the vacuum at a calcining temperature of from 65° to 85° C. for a predetermined calcining time of from 3 hours to 10 hours, wherein the maintaining is effective to at least partially remove water of crystallization from the gypsum dihydrate to convert the composition to a product comprising gypsum hemihydrate.

29. The method of claim 28, wherein the product consists of beta gypsum hemihydrate.

30. The method of claim 28, wherein the product has a compressive strength of at least 3000 psi.

31. The method of claim 1, where the composition comprises up to 10% moisture.

32. A method for calcining gypsum, the method comprising: subjecting a composition comprising gypsum dihydrate to a vacuum of from 25 mbar to 50 mbar; and maintaining the composition under the vacuum at a calcining temperature of from 65° to 85° C. for a predetermined calcining time, wherein the maintaining is effective to at least partially remove water of crystallization from the gypsum dihydrate to convert the composition to a product comprising gypsum hemihydrate.
